(19) United States
(12) Patent Application Publication
(10) Pub. No.: US 2003/0070267 A1
(43) Pub. Date: Apr. 17, 2003

(54) Safety catch

(76) Inventor: Tsung-Min Kung, Kaohsiung City (TW)

Correspondence Address: BACON & THOMAS, PLLC, 625 SLATERS LANE, FOURTH FLOOR, ALEXANDRIA, VA, 22314

(21) Appl. No.: 10/224,610

(22) Filed: Aug. 21, 2002

(30) Foreign Application Priority Data
Oct. 15, 2001 (TW) 090217531

(51) Int. Cl. F16B 45/04

(52) U.S. Cl. 24/600.5

(57) ABSTRACT

A safety catch using a sliding sleeve to close/open the opening of the hook thereof and a spring to support the sliding sleeve in the close position.

### BACKGROUND OF THE INVENTION

1. Field of the Invention

The present invention relates to a catch and, more particularly, to a safety catch that is easy to operate and, can positively be set between the open position and the close position.

2. Description of the Related Art

Regular catches include two types, namely, the plastic catches and the metal catches. Metal catches are commonly used in key rings. Plastic catches are commonly used in gloves, backpacks, clothes, hats, and etc. Because of the disadvantages of complicated processing procedure, ease of being covered with rust, ease of scratching external objects, metal catches are less invited. Nowadays, plastic catches have been intensively used instead of metal catches in different fields.

FIG. 8 shows a plastic spring catch A according to the prior art. This structure of plastic spring catch A comprises a link A1, a hook A2 connected to one end of the link A1, and a spring tongue A3. The spring tongue A3 has a fixed end connected to one end of the link A1 adjacent to the hook A2 and a free end stopped at the inner side of the hooked tip of the hook A2. When forcing the free end of the spring tongue A3 inwards, the hook A2 is opened for hooking. When released the hand from the spring tongue A3, the free end of the spring tongue A3 is forced by the springy material property of the spring tongue A3 to close the hook A2 again. This structure of spring catch A is still not satisfactory in function because of the drawbacks bellows:

1. When fastened to an object, the spring tongue A3 tends to be forced inwards from the close position to the open position accidentally, thereby causing the caught object to slip away from the spring catch A.

2. When the spring catch A fastened to a heavy object, the heavy weight of the caught object may force the spring tongue A3 sideways, causing the spring tongue A3 to be biased. In this case, the caught object may escape out of the spring catch A. When the spring catch A used to catch a precious object, for example, a notebook computer, the user may encounter a big loss.

### SUMMARY OF THE INVENTION

The present invention has been accomplished to provide a safety catch, which eliminates the aforesaid drawbacks. It is therefore main object of the present invention to provide a safety catch, which is easy to operate. It is another object of the present invention to provide a safety catch, which does not slip from the object to which the safety catch is fastened. To achieve these and other objects of the present invention, the safety catch comprises a link, a hook connected to one end of the link, the hook comprising a hooked hook element and a straight hook element, a sliding sleeve sleeved onto the straight hook element and moved along the straight hook element relative to the free end of the hooked hook element to close/open the opening between the straight hook element and the hooked hook element, and a spring member mounted in the straight hook element and stopped against a part inside the sliding sleeve to hold the sliding sleeve in the close position.

### BRIEF DESCRIPTION OF THE DRAWINGS

FIG. 1 is an exploded view of a safety catch according to the present invention.

FIG. 2 is an elevational assembly view of the safety catch according to the present invention.

FIG. 3 is a side plain view of the safety catch according to the present invention.

FIG. 4 is similar to FIG. 2 but showing the hook opened.

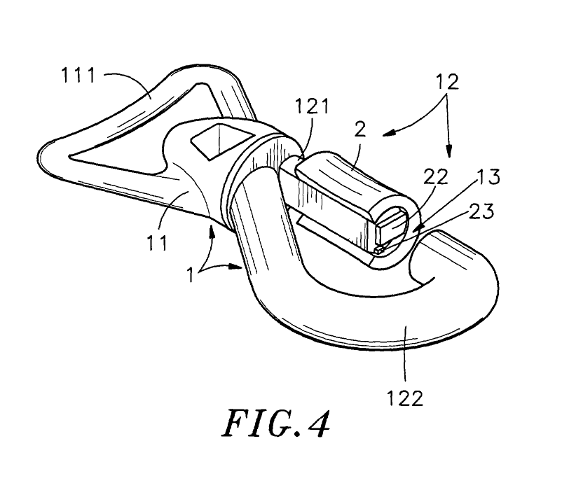

FIG. 5 is a side view, partially in section, of the present invention showing the hook closed

FIG. 6 is similar to FIG. 5 but showing the hook opened.

FIG. 7 is an applied view of the present invention, showing the link of the safety hook fastened to a fabric belt.

FIG. 8 is an elevational view of a spring catch according to the prior art.

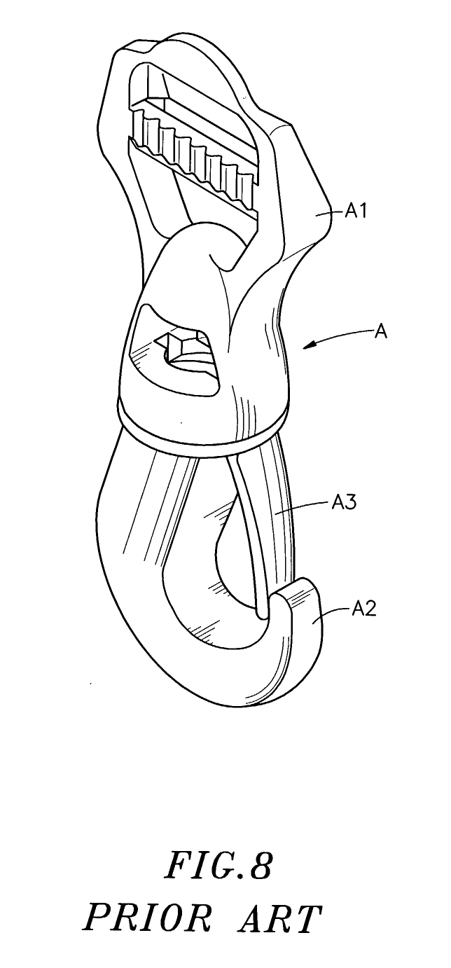

### DETAILED DESCRIPTION OF THE PREFERRED EMBODIMENT

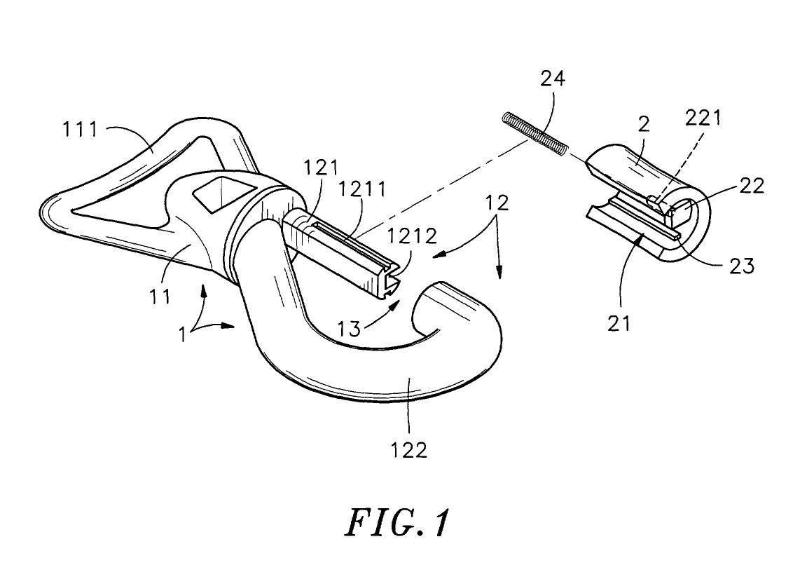

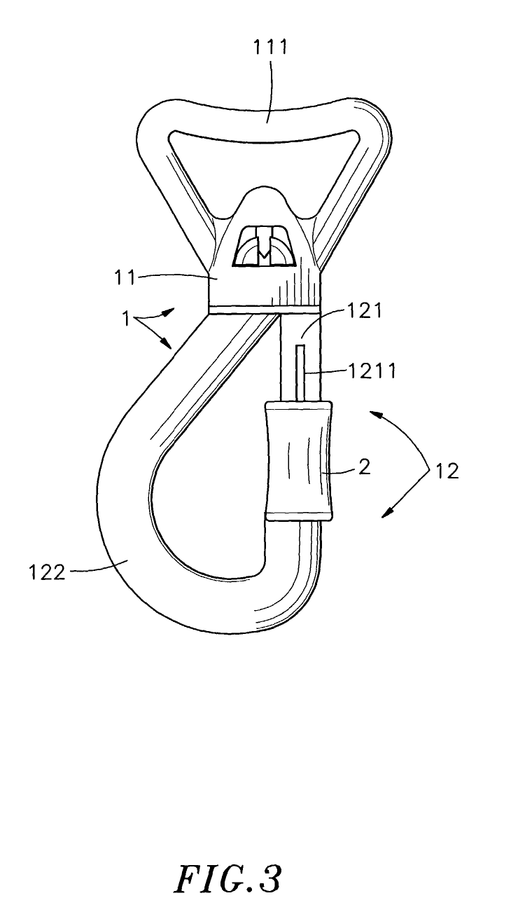

Referring to FIGS. 1, 2, and 3, a safety catch in accordance with the present invention is shown comprised of a catch 1, a spring member 24, and a sliding sleeve 2.

The catch 1 comprises a link 11, and a hook 12 pivoted to one end of the link 11. The hook 12 comprises a first hook element 121 and a second hook element 122 connected in parallel to one end of the link 11, and an opening 13 defined between the free end of the first hook element 121 and the free end of the second hook element 122. The first hook element 121 is a straight bar having a track 1212 longitudinally extended to the free end, and two longitudinal sliding grooves 1211 longitudinally extended to the free end at two sides of the track 1212.

The sliding sleeve 2 is a split sleeve of substantially C-shaped cross section coupled to the first hook element 121 of the hook 12 and moved to and away from the free end of the second hook element 122 to close/open the opening 13 of the hook 12. The sliding sleeve 2 comprises a longitudinally extended receiving open chamber 21 adapted to receive the first hook element 121 and the free end of the second hook element 122, a stop block 22 transversely suspended in the longitudinally extended receiving open chamber 21 near one end, namely, the bottom end of the sliding sleeve 2 and spaced from the bottom end of the sliding sleeve 2 at a distance, a stub rod 221 perpendicularly extended from the stop block 22 and suspended in the longitudinally extended receiving open chamber 21, and two longitudinal rails 23 bilaterally disposed inside the longitudinally extended receiving open chamber 21 corresponding to the longitudinal sliding grooves 1211 of the first hook element 121.

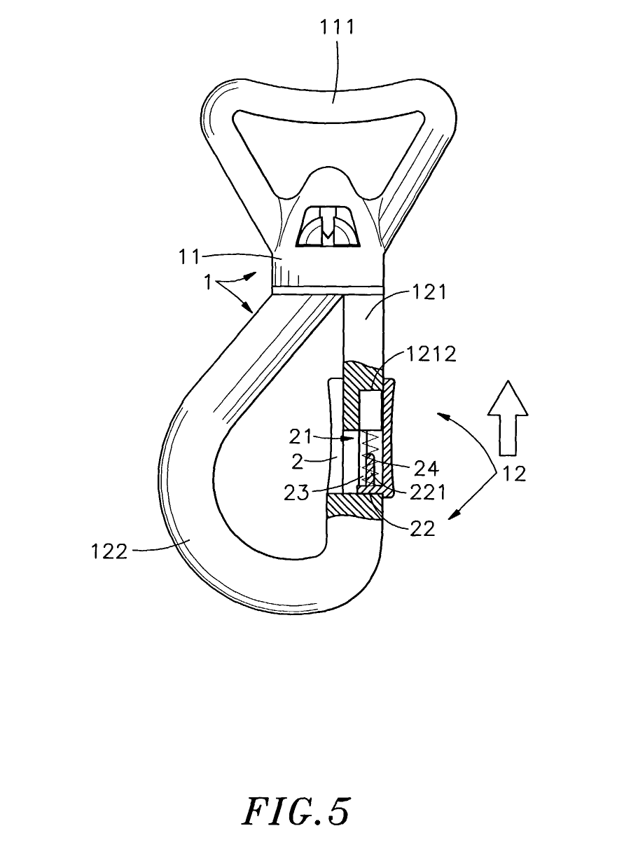

The assembly process of the present invention is outlined hereinafter with reference to FIG. 5 and FIGS. 1 and 2 again. The spring member 24 is sleeved onto the stub rod 221 of the sliding sleeve 2, and then the sliding sleeve 2 is coupled to the first hook element 121 to force the spring member 24 into the track 1212 and the longitudinal rails 23 into the longitudinal sliding grooves 1211 respectively. When released the hand from the sliding sleeve 2, the spring member 24 forces the sliding sleeve 2 toward the free end of the second hook element 122, thereby causing the stop block 22 to be stopped at the free end of the second hook element 122 and the free end of the second hook element 122 to be engaged into the bottom end of the longitudinally extended receiving chamber 21 of the sliding sleeve 2, and therefore the sliding sleeve 2 closes the opening 13 of the hook 12.

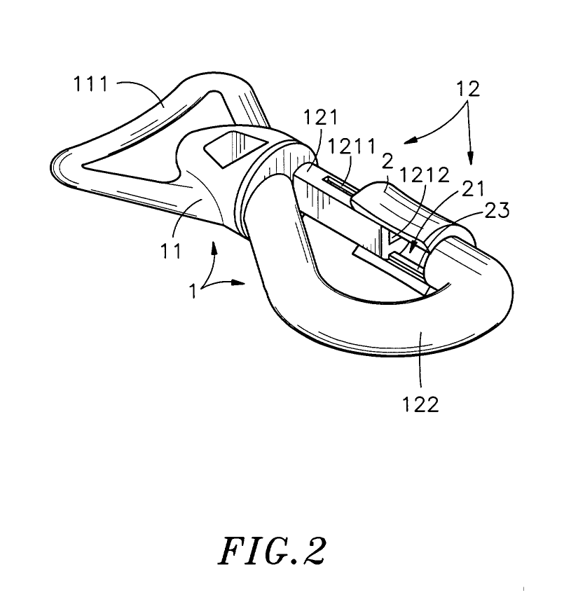

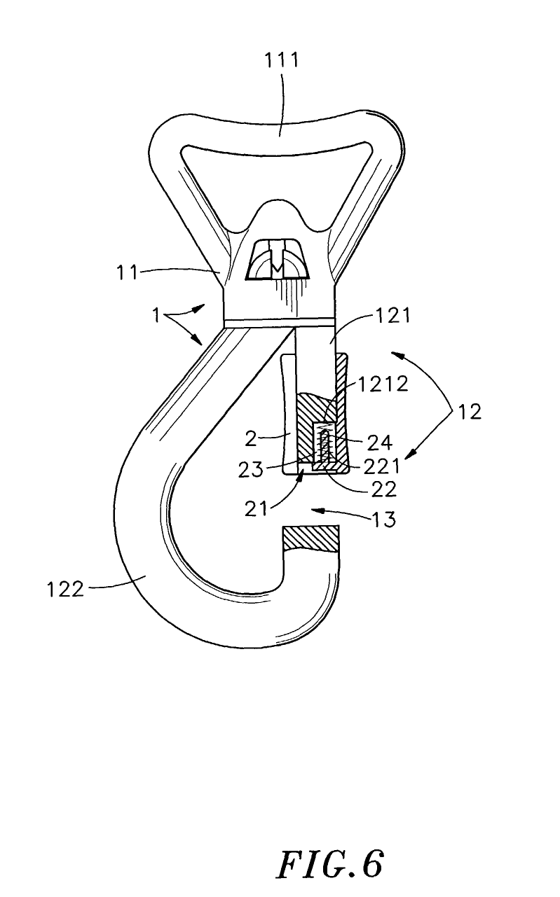

Referring to FIG. 6 and FIGS. 2, 4, and 5 again, when in use, the sliding sleeve 2 is moved upwardly away from the free end of the second hook element 122 along the first hook element 121 toward the link 11 to force the stop block 22 in the track 1212 against the spring member 24 and to open the opening 13, for enabling the hook 12 to be fastened to the matching object. When the hook 12 fastened to the matching object, the sliding sleeve 2 is released from the hand, for enabling the spring member 24 to push the sliding sleeve 2 backward into engagement with the free end of the second hook element 122 to close the opening 13.

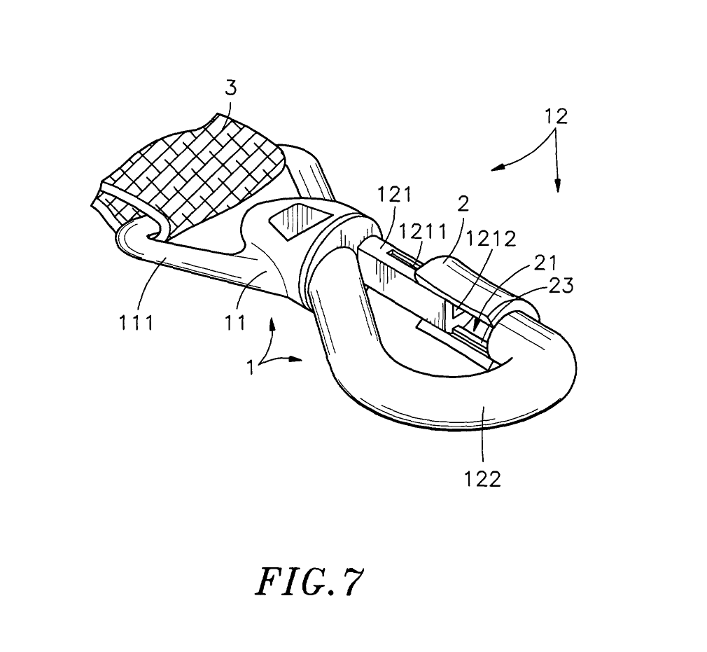

Referring to FIG. 7, the link 11 has a mounting ring 111 adapted for fastening to a belt 3. After insertion of the belt 3 through the mounting ring 111, the ends of the belt 3 are fixedly fastened to a part of a bag, clothes, etc. by stitches.

In the aforesaid embodiment, the hook 12 is pivoted to the link 11. Alternatively, the hook 12 can be fixedly connected to or formed integral with one end of the link 11.

A prototype of safety catch has been constructed with the features of the annexed drawings of FIGS. 1˜7. The safety catch functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A safety catch comprising
a link;
a hook connected to one end of said link, said hook comprising a hooked hook element, said hooked hook element having a fixed end connected to said link and a free end, a straight hook element, said straight hook element having a fixed end connected to said link and a free end, and an opening defined between the free end of said hooked hook element and said straight hook element; and
a sliding sleeve coupled to said straight hook element and axially movable along said straight hook element to close/open said opening;
wherein:
said sliding sleeve has a spring member mounted on the inside thereof and inserted into said straight hook element and stopped at a part inside said straight hook element to force said sliding sleeve into engagement with the free end of said hooked hook element to close said opening.

2. The safety catch as claimed in claim 1, said straight hook element has a longitudinal track extended to the free end thereof and adapted to receive said spring member; said sliding sleeve has a transverse stop block movable in said longitudinal track of said straight hook element and adapted to hold said spring member in said longitudinal track of said straight hook element.

3. The safety catch as claimed in claim 2, wherein said sliding sleeve has a stub rod perpendicularly extended from said stop block and inserted into one end of said spring member to support said spring member in said track of said straight hook element.

4. The safety catch as claimed in claim 1, wherein said straight hook element has two longitudinal sliding grooves at two sides; said sliding sleeve has two longitudinal rails respectively coupled to the longitudinal sliding grooves of said straight hook element.

5. The safety catch as claimed in claim 1, wherein said sliding sleeve is a split sleeve having a C-shaped cross section.

6. The safety catch as claimed in claim 1, wherein said link comprises a mounting ring disposed at one end opposite to said hook and adapted for mounting.
